(19) United States
(12) Patent Application Publication
(10) Pub. No.: US 2017/0220996 A1
(43) Pub. Date: Aug. 3, 2017

(54) Apparatus and Method For Maintaining a Delivered-Package Vault

(71) Applicant: Wal-Mart Stores, Inc., Bentonville, AR (US)

(72) Inventors: Donald R. High, Noel, MO (US); Sai Phaneendra Sri Harsha Viswanath Putcha, Bentonville, AR (US)

(21) Appl. No.: 15/418,266

(22) Filed: Jan. 27, 2017

Related U.S. Application Data
(60) Provisional application No. 62/288,556, filed on Jan. 29, 2016.

(51) Int. Cl. G06Q 10/08; G06Q 10/06; G07C 9/00

(52) U.S. Cl. CPC G06Q 10/0832; G07C 9/00142; G06Q 10/06311

(57) ABSTRACT

An enterprise facility having a plurality of enterprise associates can further have a plurality of delivered-package vaults that each have a selectively-lockable access portal. At least some of these delivered-package vaults are not generally assigned to any particular associate but instead are assigned on an as-needed basis. At least some of the delivered-package vaults include a sensor disposed and configured to detect a level of sanitation within the delivered-package vault. The control circuit operably couples to that sensor and serves to detect a level of sanitation within the corresponding delivered-package vaults to determine when cleaning of a particular one of those delivered-package vaults is required. By one approach the control circuit can automatically task one or more persons with cleaning a delivered-package vault that requires such attention.

### CROSS-REFERENCE TO RELATED APPLICATION

This application claims the benefit of U.S. Provisional Application No. 62/288,556, filed Jan. 29, 2017, and is incorporated herein by reference in its entirety.

### TECHNICAL FIELD

These teachings relate generally to delivered-package vaults.

### BACKGROUND

Delivered-package vaults are known in the art. Generally speaking, a delivered-package vault typically comprises a container having at least one access portal such as a hinged door. In many cases the access portal can be selectively locked.

An ever-diversifying variety of items are becoming available for delivery. These items include both perishable and durable goods. In many areas delivery times are also becoming shorter, with deliveries of ordered items sometimes being consummated within hours if not only minutes.

A delivered-package vault located at a person's residence can serve to receive such a delivery. There are times, however, when a person may wish to receive a personal delivery at their place of business. There are numerous problems that challenge the use of delivered-package vaults for individual associates at a place of business.

### BRIEF DESCRIPTION OF THE DRAWINGS

The above needs are at least partially met through provision of the apparatus and method for maintaining a delivered-package vault described in the following detailed description, particularly when studied in conjunction with the drawings, wherein:

FIG. 1 comprises a block diagram as configured in accordance with various embodiments of these teachings;

FIG. 2 comprises a block diagram as configured in accordance with various embodiments of these teachings; and

FIG. 3 comprises a flow diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, an enterprise facility having a plurality of enterprise associates can further have a plurality of delivered-package vaults that each have a selectively-lockable access portal. At least some of these delivered-package vaults are not generally assigned to any particular associate but instead are assigned on an as-needed basis. At least some of the delivered-package vaults include a sensor disposed and configured to detect a level of sanitation within the delivered-package vault. The control circuit operably couples to that sensor and serves to detect a level of sanitation within the corresponding delivered-package vaults to determine when cleaning of a particular one of those delivered-package vaults is required. By one approach the control circuit can automatically task one or more persons with cleaning a delivered-package vault that requires such attention.

By one approach the control circuit further serves to automatically assign a code to unlock a particular selectively-lockable access portal at a time of need. The control circuit can further serve to communicate that code to a particular associate of the enterprise facility (in particular, the particular associate to whom a delivered package is addressed) such that that associate can access the corresponding delivered-package vault.

These teachings are highly flexible in practice and will accommodate, if desired, monitoring a temperature within a delivered-package vault and using one or more temperature controllers to maintain that temperature within a particular desired range. By one approach the control circuit can control the temperature as a function, at least in part, of a package contained within the delivered-package vault.

So configured, these teachings will help maintain a block of delivered-package vaults in a sanitary state notwithstanding that the delivered-package vaults are not generally assigned to any one associate. This capability can be particularly effective in an application setting where no one associate is constantly responsible for maintaining the sanitary state of any particular delivered-package vault.

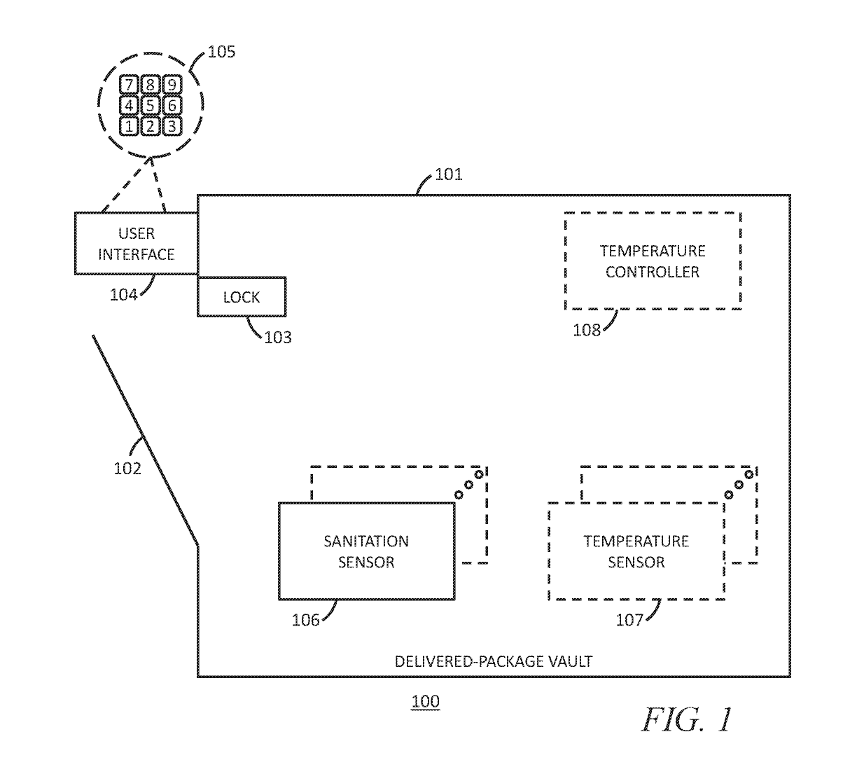

These and other benefits may become clearer upon making a thorough review and study of the following detailed description. Referring now to the drawings, and in particular to FIG. 1, an illustrative delivered-package vault 100 that is compatible with many of these teachings will be presented.

In this illustrative example the delivered-package vault 100 comprises a container 101 having at least one selectively-lockable access portal 102. The container 101 can have any size and/or shape as may suit the needs or requirements of a given application setting. Similarly, the container 101 can be comprised of one or more materials (such as, for example, any of a variety of metals, plastics, and/or various composites) that are appropriate to meet anticipated needs. The selectively-lockable access portal 102 can comprise, for example, a hinged door, a rolling shutter, a pair of opposing hinged doors, or otherwise as desired. Again, the selectively-lockable access portal 102 can have any desired size and/or shape and may be comprised of any suitable material.

A lock 103 provides a mechanism for locking the selectively-lockable access portal 102 in a closed state. A wide variety of locking mechanisms are known in the art. As the present teachings are not particularly sensitive to any particular choices in these regards, further elaboration regarding the lock 103 will not be provided here for the sake of brevity save to note that the lock 103 can be, if desired, remotely operated as described further herein.

These teachings also anticipate that the lock 103 can be operated via a user interface 104. The user interface 104 can comprise any suitable human-machine interface such as, by way of example and not by way of limitation, a physical keypad 105. Other approaches can of course be utilized including but not limited to touch-screen interfaces, wireless readers, biometric sensors, voice recognition components, and so forth. Generally speaking the user interface 104 is disposed external to the container 101 though likely affixed thereto.

So configured, the selectively-lockable access portal 102 can be unlocked by, for example, a user entering a correct code via the user interface 104. By one approach, and as described further herein, the code can be remotely set by a remote control circuit if desired.

In this illustrative example the delivered-package vault 100 further includes at least one sanitation sensor 106. This sanitation sensor 106 is disposed and configured within the container 101 to detect a level of sanitation within the delivered-package vault 100. (As used herein, it will be understood that a sensor that merely detects whether a package is present or absent from a container is not a sanitation sensor.) These teachings will accommodate a variety of sensors to serve in these regards.

By one approach, for example, the sanitation sensor 106 comprises a moisture sensor. A moisture sensor can serve to detect when, for example, there is moisture on the bottom surface and/or sides of the container 101. Moisture, in turn, can comprise a helpful indicator that a spill of some kind of liquid has occurred within the delivered-package vault 100.

By another approach, in lieu of the foregoing or in combination therewith, the sanitation sensor 106 comprises a visible light and/or non-visible light image capture sensor. Such a sensor can capture images that, when compared to base-line images of a clean surface, can help to identify when a foreign material or substance is within the delivered-package vault 100.

By yet another approach, and again in lieu of the foregoing or in combination therewith, the sanitation sensor 106 can comprise a laser scanner. A laser scanner, in turn, can detect debris within the container 101 by detecting unexpected items or contents.

These teachings will accommodate other sanitation sensors as well and as may be appropriate to a given application setting.

If desired, the delivered-package vault 100 can optionally include one or more temperature sensors 107. This temperature sensor 107 can serve to detect an ambient temperature within the container 101. That sensed temperature, in turn, can be leveraged to, for example, control the temperature within the container 101 and/or to facilitate providing an alarm when the temperature within the container 101 is beyond a permissible limit.

With the foregoing in mind, the delivered-package vault 100 can also optionally include a temperature controller 108 configured to control a temperature within the delivered-package vault 100. This temperature controller 108 can include, for example, a thermostat, a heat source, and/or a cooling source. These teachings will also accommodate having the temperature controller 108 comprise a pneumatic portal through which warmed and/or cooling air can be introduced into the container 101 and/or exited therefrom. Accordingly, the temperature controller 108 can comprise an autonomous self-contained apparatus if desired or can comprise only a component for a larger (and perhaps partially remotely located) temperature control system.

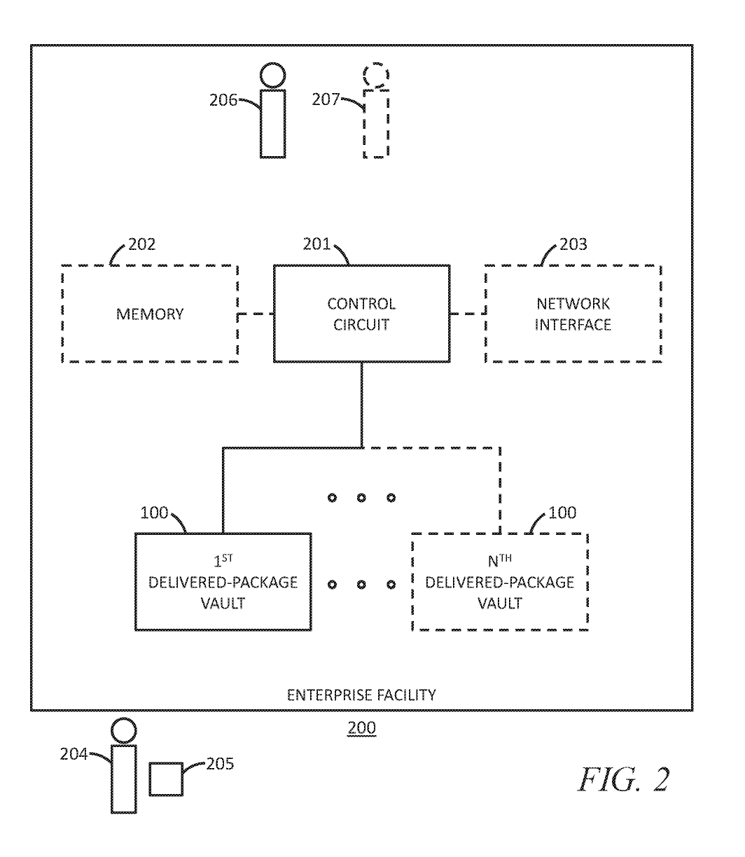

Referring now to FIG. 2, an enterprise facility 200 having a plurality of enterprise associates can be configured with at least one (and more likely a plurality) of such delivered-package vaults 100. The enterprise facility 200 itself is a physical structure such as a building.

By one approach the enterprise facility is a retail shopping facility. A retail shopping facility is a retail sales facility or any other type of bricks-and-mortar (i.e., physical) facility in which products are physically displayed and offered for sale to customers who physically visit the facility. The shopping facility may include one or more of sales floor areas, checkout locations (i.e., point of sale (POS) locations), customer service areas other than checkout locations (such as service areas to handle returns), entrance and exit areas, stock room areas, stock receiving areas, hallway areas, administrative areas, common areas shared by merchants, and so on. The facility may be any size of format facility, and may include products from one or more merchants. For example, a facility may be a single store operated by one merchant or may be a collection of stores covering multiple merchants such as a mall.

By another approach the enterprise facility is a business facility designed and operated to support any of a variety of business-related functions including administrative functions, legal functions, engineering, research and design functions, manufacturing functions, shipping functions, inventory storage and/or product distribution functions, accounting functions, customer relations functions, and so forth. Such a facility may be partitioned into separate offices, cubicles, or other private, semi-private, or group workspaces and meeting areas.

The delivered package vaults 100 may be co-located within the enterprise facility 200 or maybe located, singly or in groups, at a plurality of locations within the enterprise facility 200. The delivered-package vaults 100 may be located within a public area of the enterprise facility 200 or may be located within a restricted area. Access to the restricted area may be controlled via one or more locks that are responsive to the use of an appropriate key, code, badge or other identifier, or the like.

It will be presumed here that a control circuit of choice carries out at least some of the actions, steps, and/or functions described herein. FIG. 2 provides an illustrative example of a control circuit 201. Being a “circuit,” the control circuit 201 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 201 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 201 is configured (for example, by using corresponding programming as will be well understood by those skilled in the art) to carry out one or more of the steps, actions, and/or functions described herein.

By one optional approach the control circuit 201 operably couples to an optional memory 202. This memory 202 may be integral to the control circuit 201 or can be physically discrete (in whole or in part) from the control circuit 201 as desired. This memory 202 can also be local with respect to the control circuit 201 (where, for example, both share a common circuit board, chassis, power supply, and/or housing) or can be partially or wholly remote with respect to the control circuit 201 (where, for example, the memory 202 is physically located in another facility, metropolitan area, or even country as compared to the control circuit 201).

This memory 202 can serve, for example, to non-transitorily store the computer instructions that, when executed by the control circuit 201, cause the control circuit 201 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

As illustrated in this example the control circuit 201 can also operably couples to an optional network interface 203. So configured the control circuit 201 can communicate with other elements (both within the enterprise facility 200 and external thereto) via the network interface 203. Network interfaces, including both wireless and non-wireless platforms, are well understood in the art and require no particular elaboration here.

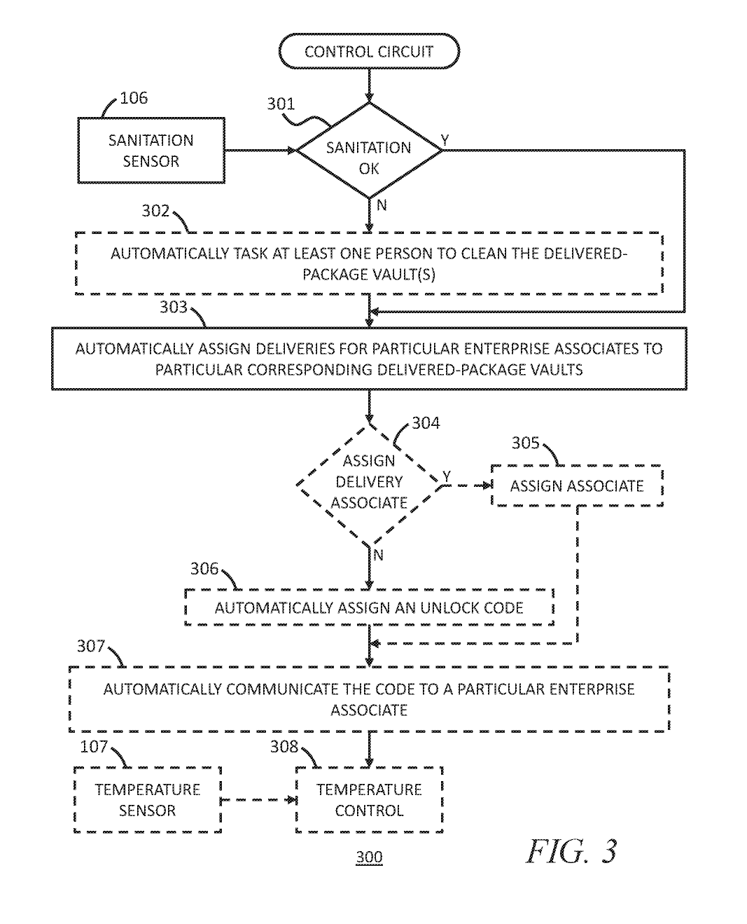

FIG. 3 presents a process 300 that the control circuit 201 can carry out in conjunction with the above-described delivered-package vaults 100. Pursuant to this process 300, at block 301, the control circuit 201 uses a detected level of sanitation within the delivered-package vaults from the one or more of the aforementioned sanitation sensors 106 to determine when cleaning of a particular one of the delivered-package vaults is required. Upon determining that cleaning is required, the control circuit 201 can take an appropriate corresponding action.

By one approach, that appropriate action might comprise sounding or otherwise providing an alert to a responsible party. By another approach, and as shown at optional block 302, the control circuit 201 can automatically task at least one person with cleaning the delivered-package vaults that requires cleaning based upon the foregoing determination. The tasked person can be an associate of the enterprise or can be, for example, an authorized third party such as a service provider hired to conduct maintenance at the enterprise facility 200.

The control circuit 201 can so task this person using, for example, an automatically-generated email or text message. Other approaches in these regards can include transmitting an alert per the functionality of a mobile device application, automatically creating and uploading a to-do task to a corresponding to-do list, and so forth.

By one approach the automatically-created task can have a corresponding associated priority. For example, the control circuit 201 may be configured to not only detect an unacceptable level of sanitation within a particular delivered-package vault 100 but may also be able to determine further attributes of the unacceptable condition. Examples include determining whether the objectionable condition is increasing in size at some unacceptable rate, or is caused by the presence of a substance of particular concern. In such a case the task can be given a higher priority when automatically created by the control circuit 201.

By another approach, in lieu of the foregoing or in combination therewith, the control circuit 201 may be configured to not only task a person but to identify particular equipment or supplies that the tasked person should bring with them to properly clean the delivered-package vault 100. Such a determination can again be based upon such things as determining the material composition of the unwanted substance, the physical state of the unwanted substance (such as whether the substance is a solid, liquid, or becoming gaseous), the volume of the unwanted substance, any risk factors that may be associated with the unwanted substance, and so forth.

And by yet another approach, and again in lieu of the foregoing or in combination therewith, the control circuit 201 may be configured to select a particular person or entity from amongst a plurality of candidates to clean the delivered-package vault 100 based upon the nature of the unwanted materials in the delivered-package vault 100. For example, it may be appropriate to select one available cleaning entity over another based upon whether the detected debris constitutes potentially hazardous material.

The control circuit 201 can perform additional tasks as regards the delivered-package vaults 100. For example, as illustrated at block 303, the control circuit 201 can automatically assign deliveries that arrive at the enterprise facility 200 for particular enterprise associates to particular corresponding delivered-package vaults 100. With reference as well to FIG. 2, this can comprise, for example, directing a delivery person 204 who arrives at the enterprise facility 200 with a package 205 intended for a particular associate 206 who works at the enterprise facility 200 to a particular and specific delivered-package vault 100. Those directions can be provided in any of a variety of ways (for example, via email or a text message, via a display at the enterprise facility 200, or otherwise as desired). That delivery person 204 can then place the package 205 in the designated delivered-package vault 100 following which the selectively lockable access portal 102 for that particular delivered-package vault 100 can be locked.

In many cases it will be expected and appropriate that the intended recipient for the package 205 will be the associate who personally accesses the delivered-package vault 100 that contains their package 205. Other circumstances, however, can arise. For example, there can be times or situations when it may be more appropriate that another person retrieve the package 205 from the delivered-package vault 100 and personally bring that package 205 to the particular associate 206 for whom the package 205 is intended.

To accommodate such a circumstance, and as illustrated at optional blocks 304 and 305, the control circuit 201 can determine whether to assign a different enterprise associate 207 to access the particular delivered-package vault 100 to thereby retrieve the package 205 and transport the package 205 to the enterprise associate 206 who constitutes the delivery target for the package 205. When appropriate, at block 305 circuit 201 can so assign this intermediary associate. The control circuit 201 can then, if desired, notify and provide this intermediary associate 207 with information relevant to this task via email, text messaging, an internal enterprise paging system, or any other mechanism of choice.

By one approach the code utilized to unlock the locker 103 of a given delivered-package vault 100 can be dynamically changed by the control circuit 201 via an appropriate wireless or non-wireless connection therebetween. In such a case, at optional block 306 the control circuit 201 can automatically assign an unlock code to a particular delivered-package vault 100 and, at block 307, automatically communicate that code to a particular enterprise associate such as the aforementioned intended recipient 206 or an intermediary associate 207 tasked with accessing the delivered-package vault 100 and bringing the package 205 to the intended recipient 206.

As noted above, these teachings will accommodate providing the delivered-package vault 100 with one or more temperature sensors 107 and a way to control the temperature 108 of the delivered-package vault 100. In such a case and as illustrated at optional block 308 the control circuit 201 can contribute, partially or wholly, to controlling that temperature in response to such a temperature sensor 107.

By one approach the control center 201 can control this temperature as a further function, at least in part, of the package 205 that is contained within the delivered-package vault 100. For example, when the package comprises perishable fresh food items, the control circuit 201 can control the temperature to provide a refrigerated internal temperature. When the package comprises an item that is relatively temperature insensitive, however, the control circuit 201 may eschew any temperature control.

The foregoing examples are intended to serve in an illustrative capacity and are not intended to suggest or represent a complete and exhaustive listing of alternative and/or optional functionality in these regards.

So configured, an enterprise can maintain a plurality of delivered-package vaults that are not generally assigned to any one individual. These delivered-package vaults can be utilized to receive packages, including personal packages, for various associates of the enterprise on an as-needed basis. Although no one in particular is immediately responsible for maintaining the cleanliness of any one of these delivered-package vaults, these teachings help ensure that the delivered-package vaults are well maintained and are not unsanitary.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus comprising:
a delivered-package vault having a selectively-lockable access portal;
at least one sensor disposed and configured to detect a level of sanitation within the delivered-package vault.

2. The apparatus of claim 1 further comprising:
a temperature controller configured to control a temperature within the delivered-package vault.

3. The apparatus of claim 1 further comprising:
an enterprise facility;
wherein the delivered-package vault is disposed within the enterprise facility.

4. The apparatus of claim 3 further comprising:
a control circuit operably coupled to the selectively-lockable access portal and configured to automatically assign to the selectively-lockable access portal a code to unlock the selectively-lockable access portal.

5. The apparatus of claim 4 wherein the control circuit is further configured to communicate the code to a particular associate of the enterprise facility such that the particular associate can access the delivered-package vault.

6. The apparatus of claim 5 wherein the control circuit is further configured to communicate to the particular associate when there is a delivery in the delivered-package vault for the particular associate.

7. The apparatus of claim 4 wherein the control circuit is also operably coupled to the sensor.

8. The apparatus of claim 7 wherein the control circuit is further configured to use a detected level of sanitation within the delivered-package vault to determine when cleaning of the delivered-package vault is required.

9. The apparatus of claim 8 wherein the control circuit is further configured, upon determining that cleaning of the delivered-package vault is required, to automatically task at least one person with cleaning the delivered-package vault.

10. A method comprising:
at an enterprise facility having a plurality of enterprise associates and a plurality of delivered-package vaults that each have a selectively-lockable access portal, and by a control circuit that operably couples to at least one sensor disposed and configured to detect a level of sanitation within the delivered-package vault:
automatically assign deliveries for particular ones of the enterprise associates to particular corresponding ones of the delivered-package vaults;
automatically use a detected level of sanitation within the delivered-package vaults to determine when cleaning of a particular one of the delivered-package vaults is required.

11. The method of claim 10 further comprising:
upon determining that cleaning of a particular one of the delivered-package vaults is required, automatically tasking at least one person with cleaning the particular one of the delivered-package vaults.

12. The method of claim 10 further comprising:
controlling a temperature within the delivered-package vault.

13. The method of claim 12 wherein the control circuit controls the temperature within the delivered-package vault as a function, at least in part, of a package contained within the delivered-package vault.

14. The method of claim 10 further comprising:
automatically assigning to the selectively-lockable access portals a corresponding code to unlock the selectively-lockable access portal.

15. The method of claim 11 wherein the control circuit automatically assigns the codes to unlock the selectively-lockable access portals dynamically as needed on a delivery-by-delivery basis.

16. The method of claim 15 further comprising:
automatically communicating the code for a particular selectively-lockable access portal to a particular enterprise associate such that the particular associate can access the delivered-package vault that corresponds to the particular selectively-lockable access portal.

17. The method of claim 15 further comprising:
subsequent to a package being placed within a particular one of the delivered-package vaults, determining whether to assign a first enterprise associate to access the particular one of the delivered-package vaults to thereby retrieve the package and transport the package to a second enterprise associate who constitutes the delivery target for the package.
